(19) United States
(12) Patent Application Publication
(10) Pub. No.: US 2017/0123294 A1
(43) Pub. Date: May 4, 2017

(54) SENSOR CONTROL SYSTEM AND RELATED METHODS

(71) Applicant: Huf North America Automotive Parts Mfg. Corp., Milwaukee, WI (US)

(72) Inventors: Mansour Ashtiani, Novi, MI (US); David Newkirk, West Bloomfield, MI (US)

(21) Appl. No.: 15/336,949

(22) Filed: Oct. 28, 2016

Related U.S. Application Data
(60) Provisional application No. 62/248,887, filed on Oct. 30, 2015.

(51) Int. Cl. G03B 11/04; B60R 1/00; G02F 1/133

(52) U.S. Cl. CPC G03B 11/045; G02F 1/13318; B60R 1/00; G02F 2001/13312; G02F 2203/01; G02F 2203/03; B60R 2300/8026

(57) ABSTRACT

A sensor assembly is provided and includes a housing having a window, a sensor disposed within the housing, and a shield supported by the housing. The shield operates in a first state permitting the sensor to be visible through the window and a second state restricting visibility of the sensor through the shield.

### CROSS REFERENCE TO RELATED APPLICATIONS

This U.S. patent application claims priority under 35 U.S.C. §119(e) to U.S. Provisional Application Ser. No. 62/248,887, filed on Oct. 30, 2015. The disclosure of this prior application is considered part of the disclosure of this application and is hereby incorporated by reference in its entirety.

### FIELD

The present disclosure relates generally to sensor control and more particularly to systems and methods for controlling exposure of a sensor.

### BACKGROUND

This section provides background information related to the present disclosure and is not necessarily prior art.

Many motor vehicles now come equipped with some variation of a camera and sensor system to provide real-time monitoring or viewing of an area near the motor vehicle. For example, cameras, sensors, or both are often positioned on the front of the vehicle, the rear of the vehicle, or on either of the sides (e.g., driver side or passenger side) of the vehicle. The cameras and sensors can detect the areas surrounding the vehicle that are not otherwise viewable with conventional mirrors. Such cameras and sensors can be used to assist the vehicle operator in parking or maneuvering the vehicle during normal operation or to monitor conditions in the areas surrounding the vehicle, for example.

In some applications, it may be desirable to provide a sensor that is selectively exposed (e.g., visible) to the areas surrounding the vehicle. For example, considerations such as aesthetics and/or privacy may make it desirable for both fixed and deployable sensors to be hidden (e.g., invisible) to the areas surrounding the vehicle when the sensor is not in use. In this regard, some vehicles may utilize a deployable sensor system in which the sensor is selectively deployable and/or stowable. Accordingly, such a sensor can be deployed when it desirable to monitor the area surrounding the vehicle, and stowed when it is desirable to hide the sensor relative to the area surrounding the vehicle.

### SUMMARY

This section provides a general summary of the disclosure, and is not a comprehensive disclosure of its full scope or all of its features.

A sensor assembly is provided and includes a housing having a window, a sensor disposed within the housing, and a shield supported by the housing. The shield operates in a first state permitting the sensor to be visible through the window and a second state restricting visibility of the sensor through the shield.

In one configuration, the sensor includes a camera. Additionally or alternatively, the shield may include liquid crystal molecules that are aligned in the first state to permit incident light to pass through the shield and are randomly orientated in the second state to scatter incident light. The shield may be clear in the first state and may be opaque in the second state. A voltage may be applied to the liquid crystal molecules to move the shield from the second state to the first state.

The shield may be clear in the first state and may be opaque in the second state.

In one configuration, a voltage may be applied to the shield to move the shield from the second state to the first state. Additionally or alternatively, the shield may be moved from the second state to the first state based on a state of the sensor. The sensor may be movable between an ON state and an OFF state. The shield may be moved from the second state to the first state when the sensor is moved from the OFF state to the ON state.

In another configuration, a sensor control system is provided and includes an input device that controls a state of a sensor between an ON state and an OFF state, a sensor activation module that determines the state of the sensor, and a shield control module that controls an opacity of a shield based on the state of the sensor.

The shield control module may reduce the opacity of the shield when the sensor is in the ON state. Further, the shield control module may increase the opacity of the shield when the sensor is in the OFF state.

In one configuration, the shield may include liquid crystal molecules that are aligned in a first state to permit incident light to pass through the shield and are randomly orientated in a second state to scatter incident light. The shield control module may control the shield in the first state when the sensor is in the ON state and may control the shield in the second state when the sensor is in the OFF state. The shield may be clear in the first state and may be opaque in the second state. A voltage may be applied to the liquid crystal molecules to move the shield from the second state to the first state.

A method of controlling a sensor system is also provided and includes determining a state of a sensor disposed behind a shield, increasing an opacity of the shield when the state of the sensor is in an OFF state, and reducing an opacity of the shield when the state of the sensor is in an ON state.

In one configuration, increasing the opacity of the shield includes making the sensor invisible through the shield. Additionally or alternatively, reducing the opacity of the shield includes making the sensor visible through the shield. Reducing the opacity of the shield may include applying a voltage to the shield. Applying a voltage to the shield may include applying a voltage to liquid crystal molecules to align the liquid crystal molecules and permit incident light to pass through the shield.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1A is a side view of a vehicle having a sensor system in accordance with the principles of the present disclosure;

FIG. 1B is a rear view of a vehicle having a sensor system in accordance with the principles of the present disclosure;

FIG. 2A is a perspective view of a sensor system in a first state according to the principles of the present disclosure and shown in conjunction with a schematic housing;

FIG. 2B is a perspective view of a sensor system in a second state according to the principles of the present disclosure and shown in conjunction with a schematic housing;

FIG. 3 is a cross-sectional view of the sensor system of FIG. 1B taken through the line 3-3;

FIG. 4 is a functional block diagram of an example control system in accordance with the principles of the present disclosure; and

FIG. 5 is a flowchart depicting an example method for controlling a sensor system in accordance with the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

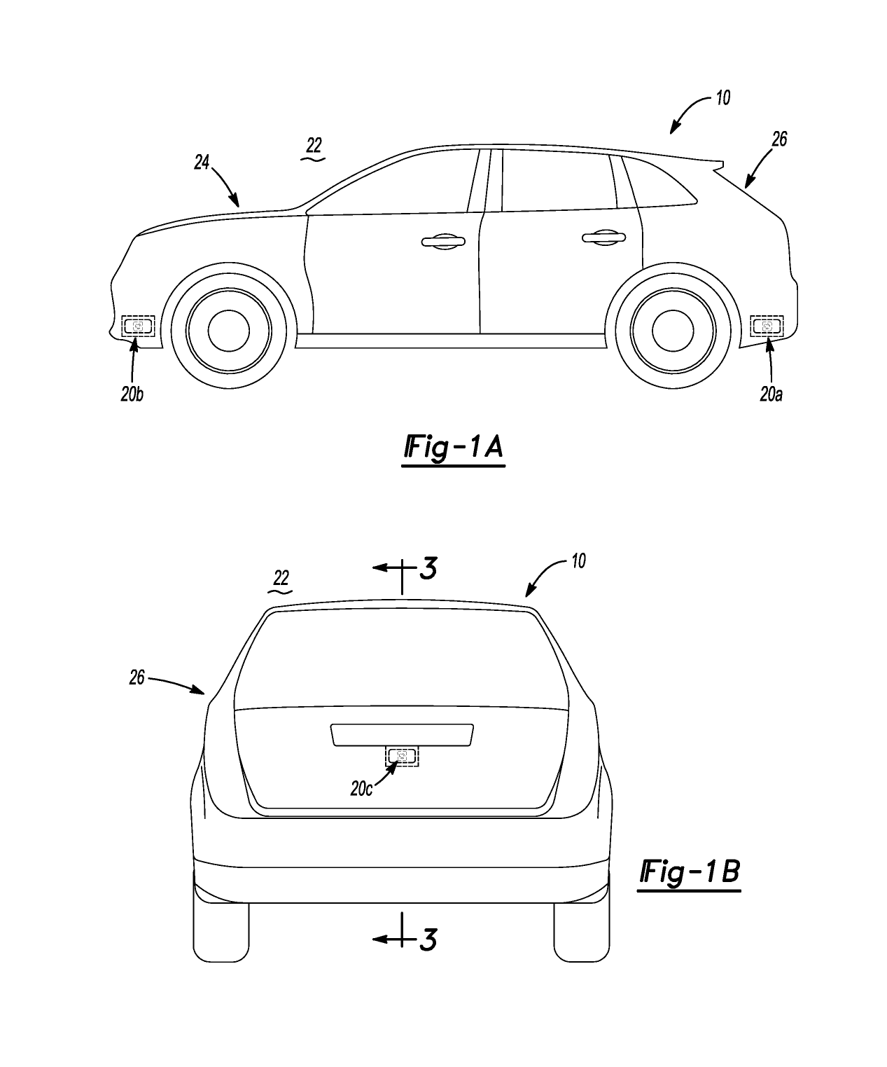

With reference to FIGS. 1A and 1B, a vehicle 10 is provided. The vehicle 10 may be any known variety of vehicle, such as a car, a truck, or a van for example. The vehicle 10 may include one or more sensor assemblies 20 that can monitor various conditions in an area 22 external to the vehicle 10. For example, the vehicle 10 may include a first sensor assembly 20a disposed on a rear portion 24 (e.g., disposed proximate a rear bumper) of the vehicle 10, a second sensor assembly 20b disposed on a front portion 26 (e.g., disposed proximate a front bumper) of the vehicle 10, and a third sensor assembly 20c disposed on the rear portion 26 (e.g., disposed on a trunk or tailgate portion) of the vehicle 10. It will be appreciated that the sensor assemblies 20 (e.g., the first, second, and/or third sensor assemblies 20a, 20b, 20c) may be disposed in other locations on the vehicle 10 within the scope of the present disclosure.

As will be explained in more detail below, the exposure (e.g., visibility) of each sensor assembly 20 relative to the area 22 external to the vehicle 10 may be selectively controllable. In particular, the sensor assemblies 20 may be controllable between a first state and a second state. In the first state (e.g., first sensor assembly 20a), the sensor assembly 20 may be exposed to the area 22 external to the vehicle 10. In this regard, in the exposed state, the sensor assembly 20 may monitor various conditions in the area 22 external to the vehicle 10. In the second state (e.g., second sensor assembly 20b), the sensor assembly 20 may be hidden and/or concealed from the area 22 external to the vehicle 10. In this regard, in the unexposed state, the sensor assembly 20 may be prevented from monitoring, and hidden relative to, the area 22 external to the vehicle 10.

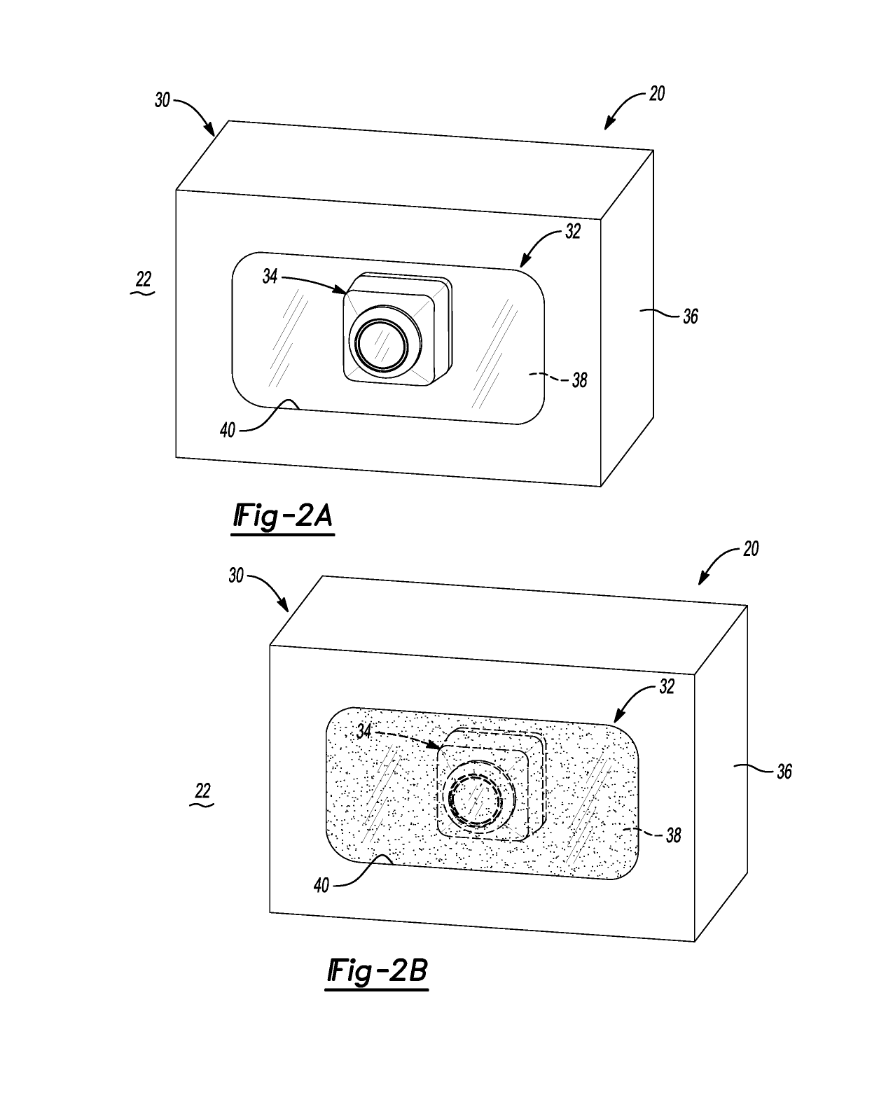

With reference to FIGS. 2A and 2B, the sensor assembly 20 (e.g., the first, second, and/or third sensor assembly 20a, 20b, 20c) may include a housing 30, a shield 32, and a sensor 34. The housing 30 may include one or more walls 36 surrounding an inner chamber 38. The wall 36 may include a window 40 (e.g., an aperture) in communication with the inner chamber 38.

In the assembled configuration, the housing 30 may be supported by the vehicle 10. In particular, the housing 30 may be mounted at one or more locations on the vehicle 10. For example, as previously discussed, in some configurations, the housing 30 may be mounted to the front portion 24, the rear portion 26, and/or other portions of the vehicle 10. In this regard, it will be appreciated that, in some configurations, the housing 30 may be integrally formed with a portion (e.g., a bumper, chassis, and/or body portion) of the vehicle 10.

The shield 32 may be supported by the housing 30. In some configurations, the shield 32 may be coupled to the housing 30 such that the shield 32 is disposed over and/or covers the window 40. As will be described in more detail below, the shield 32 may include a material(s) having light transmission properties that are selectively controllable. In particular, the shield 32 may include a material having light transmission properties that are modified when a stimulus (e.g., a voltage, light, heat, etc.) is applied to the shield 32.

In some configurations, the shield 32 may include a switchable privacy glass, such as Polyvision™, manufactured by Polytronix™, Inc. of Richardson, Tex.. In this regard, the shield 32 may be transparent and/or translucent when the sensor assembly 20 is switched to the first state (FIG. 2A), and opaque when the sensor assembly 20 is switched to the second state (FIG. 2B). In particular, the stimulus may be applied when the sensor assembly 20 is in the first state (FIG. 2B) and removed when the sensor assembly 20 is in the second state (FIG. 2A). Accordingly, when the sensor assembly 20 is in the second state, light may be inhibited from passing through the shield 32 such that the sensor 34 is concealed by, and/or not visible through, the shield 32. Conversely, when the sensor assembly 20 is in the first state, light may be allowed to pass through the shield 32 such that the sensor 34 is visible through the shield 32.

The shield 32 may include liquid crystal molecules that are randomly oriented when a stimulus such as voltage is not applied to the shield 32. Accordingly, in this state, the liquid crystal molecules scatter incident light and provide the shield 32 with an opaque appearance (FIG. 2B). Conversely, when a stimulus such as voltage is applied to the shield 32, the liquid crystal molecules line up, thereby allowing incident light to pass through the shield 32 (FIG. 2A). In this state, the shield 32 appears clear and permits use of the sensor 34 disposed within the housing 30. While the shield 32 is described as being opaque in the second state, the shield 32 may include a color that matches the color of the vehicle and/or the housing 30 surrounding the shield 32 when in the second state. For example, the shield 32 may be formed at least in part by a material such as glass having a color that is similar to the color of the surrounding vehicle structure and/or the housing 30. Accordingly, when the shield 32 is in the second state (FIG. 2B) and the sensor 34 is not visible, the shield 32 blends into the vehicle structure and gives the appearance of being part of a painted, external surface of the vehicle 10. Namely, the shield 32 has the same or approximately the same color as the surrounding structure of the vehicle 10 when in the second state.

The sensor 34 may include any variety of sensing device that can monitor a condition(s) in the area 22 external to the vehicle 10. For example, the sensor 34 may include a motion sensing device (e.g., a camera, a radar gun, etc.), an acoustic sensing device (e.g., a microphone), a temperature sensing device (e.g., a thermometer), etc. The sensor 34 may be fixed (e.g., immovable) relative to the vehicle 10 or deployable (e.g., movable) relative to the vehicle 10. In particular, in some implementations, the sensor 34 may rotate or translate relative to the vehicle 10 between a stowed position and a deployed position. As illustrated in FIGS. 2A and 2B, the sensor 34 may be disposed within the housing 30. In this regard, the sensor 34 may be disposed within housing 30 such that the shield 32 is disposed between the sensor 34 and the area 22 external to the vehicle 10. Accordingly, as previously described, when the sensor assembly 20 is in the first state, the sensor 34 may be visible from the area 22 external to the vehicle 10. Conversely, when the sensor assembly 20 is in the second state, the sensor 34 may be invisible from the area 22 external to the vehicle 10.

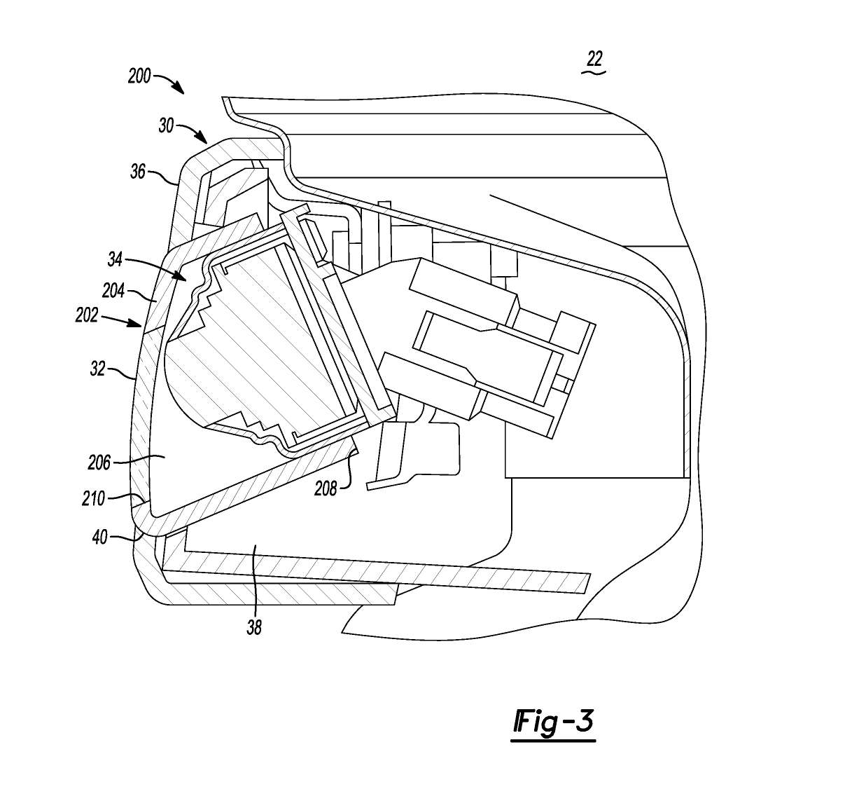

With reference to FIG. 3, another sensor assembly 200 is provided. The structure and function of the sensor assembly 200 may be substantially similar to that of the sensor assembly 20, apart from any exceptions described below and/or shown in the figures. Accordingly, the structure and function of similar features will not be described again in detail. In addition, like reference numerals are used hereinafter and in the drawings to identify like features.

The sensor assembly 200 may include the housing 30, the shield 32, the sensor 34, and a bezel 202. The bezel 202 may include one or more walls 204 surrounding an inner chamber 206. The wall 204 may include and/or define a rear opening 208 and a front window 210 (e.g., an aperture). In the assembled configuration, the bezel 202 may be disposed within the window 40 of the housing 30, the shield 32 may be disposed within the front window 210 of the bezel 202, and the sensor 34 may be disposed within the inner chamber 206 of the bezel 202 and/or within the inner chamber 38 of the housing 30. In this regard, the rear opening 208 of the bezel 202 may be in communication with the inner chamber 38 of the housing 30 such that the sensor 34 is supported by the bezel 202 within the housing 30.

The bezel 202 may include a color that matches the color of the vehicle surrounding the bezel 202. For example, the bezel 202 may be formed at least in part by a material having a color that is similar to the color of the surrounding vehicle structure. The shield 32 may include a color that matches the color of the bezel 202 when the shield 32 is in the second state. Accordingly, when the shield 32 is in the second state (FIG. 2B) and the sensor 34 is not visible, the shield 32 blends into the bezel 202 and gives the appearance of being part of a painted, external surface of the bezel 202. In this regard, the shield 32 and the bezel 202 may have the same or approximately the same color as the surrounding structure of the vehicle 10 when in the shield 32 is in the second state.

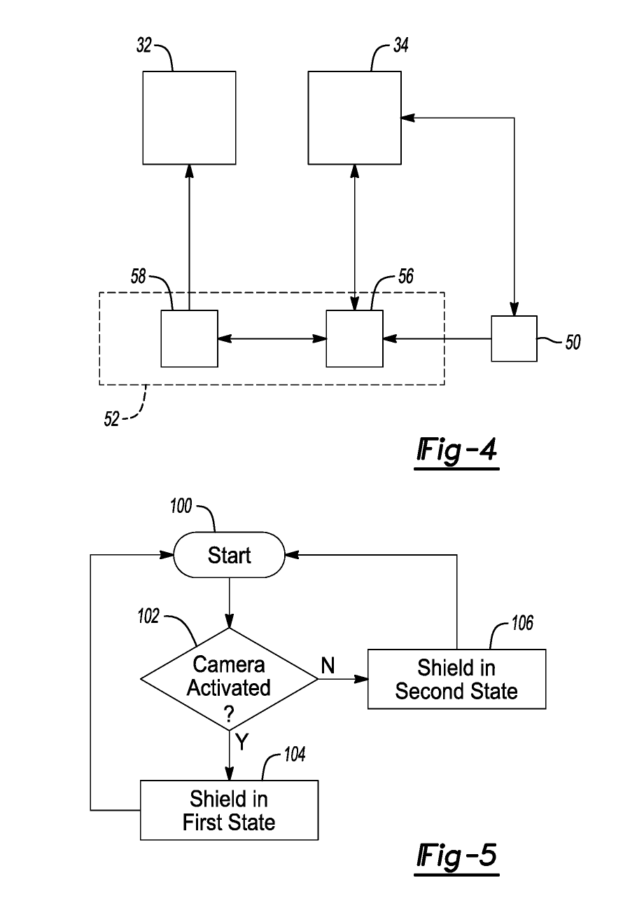

With reference to FIG. 4, a functional block diagram of a system for controlling the sensor assembly 20 is shown. The system may include an input device 50 and a system control module 52. The input device 50 may communicate with the sensor 34 to control a power state (e.g., “ON” or “OFF”) of the sensor 34. In this regard, the input device 50 may include a manual input device (e.g., a switch) or an automatic input device (e.g., a light sensor, a motion sensor, a noise sensor, etc.) that switches the sensor 34 between “ON” and “OFF” states.

The system control module 52 may control the operation of the sensor assembly 20. In particular, the system control module 52 may control the operation of the shield 32 between the first state (FIG. 2A) and the second state (FIG. 2B). In this regard, the system control module 52 may include a sensor activation module 56 and a shield control module 58.

The sensor activation module 56 may determine a state of the sensor 34. For example, the sensor activation module 54 may determine whether the sensor 34 is in the “ON” state or the “OFF” state. In this regard, the sensor activation module 54 may communicate with the input device 52 to determine the state of the sensor 34.

The shield control module 58 may control the state of the shield 32. For example, the shield control module 58 may control whether the shield 32 is in the first state (FIG. 2A) or the second state (FIG. 2B). In this regard, the shield control module 58 may communicate with the sensor activation module 56 to control the state of the shield 32 based at least in part on the state of the sensor 34. In particular, when the sensor activation module 56 determines that the sensor 34 is in the “ON” state, the shield control module 58 may control the shield 32 to be in the first state (FIG. 2A). Conversely, when the sensor activation module 56 determines that the sensor 34 is in the “OFF” state, the shield control module 58 may control the shield 32 to be in the second state (FIG. 2B).

With reference to FIG. 5, a method for controlling the sensor assembly 20 is shown. The method begins at 100. At 102, the method determines the state of the sensor 34. For example, the method may determine whether the sensor 34 is “ON” or “OFF.” In this example, the sensor 34 is identified as being a camera. While the sensor 34 is identified as being a camera in the example of FIG. 5, the sensor 34 could be any sensor, as described above.

If 102 is true, the method continues at 104 where the method controls the state of the shield 32. For example, if 102 is true, the method may switch the shield 32 to the first state (FIG. 2A). In this regard, at 102 the method may apply a stimulus (e.g., voltage, light, heat, etc.) to the shield 32 in order to reduce the opacity of the shield 32, and to allow the sensor 34 to sense one or more conditions in the area 22 surrounding the vehicle 10.

If 102 is false, the method proceeds to 106 wherein the method controls the state of the shield 32. For example, if 104 is false, the method may switch the shield 32 to the second state (FIG. 2B) or maintain the shield 32 in the second state (FIG. 2B). In this regard, at 104 the method may remove a stimulus (e.g., voltage, light, heat, etc.) from the shield 32 in order to increase the opacity of the shield 32, and to inhibit and/or prevent the sensor 34 from sensing one or more conditions in the area 22 surrounding the vehicle 10. In this regard, at 104 the method may make the sensor 34 invisible from the area 22 surrounding the vehicle 10.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A sensor assembly comprising:
a housing having a window;
a sensor disposed within the housing; and
a shield supported by the housing and operable in a first state permitting the sensor to be visible through the window and a second state restricting visibility of the sensor through the shield.

2. The sensor assembly of claim 1, wherein the sensor includes a camera.

3. The sensor assembly of claim 1, wherein the shield includes liquid crystal molecules that are aligned in the first state to permit incident light to pass through the shield and are randomly orientated in the second state to scatter incident light.

4. The sensor assembly of claim 3, wherein the shield is clear in the first state and is opaque in the second state.

5. The sensor assembly of claim 3, wherein a voltage is applied to the liquid crystal molecules to move the shield from the second state to the first state.

6. The sensor assembly of claim 1, wherein the shield is clear in the first state and is opaque in the second state.

7. The sensor assembly of claim 1, wherein a voltage is applied to the shield to move the shield from the second state to the first state.

8. The sensor assembly of claim 1, wherein the shield is moved from the second state to the first state based on a state of the sensor.

9. The sensor assembly of claim 8, wherein the sensor is movable between an ON state and an OFF state.

10. The sensor assembly of claim 9, wherein the shield is moved from the second state to the first state when the sensor is moved from the OFF state to the ON state.

11. A sensor control system comprising:
an input device that is operable to control a state of a sensor between an ON state and an OFF state;
a sensor activation module that determines the state of the sensor; and
a shield control module that controls an opacity of a shield based on the state of the sensor.

12. The sensor control system of claim 11, wherein the shield control module reduces the opacity of the shield when the sensor is in the ON state.

13. The sensor control system of claim 11, wherein the shield control module increases the opacity of the shield when the sensor is in the OFF state.

14. The sensor control system of claim 11, wherein the shield includes liquid crystal molecules that are aligned in a first state to permit incident light to pass through the shield and are randomly orientated in a second state to scatter incident light, the shield control module controlling the shield in the first state when the sensor is in the ON state and controlling the shield in the second state when the sensor is in the OFF state.

15. The sensor control system of claim 14, wherein the shield is clear in the first state and is opaque in the second state.

16. The sensor control system of claim 14, wherein a voltage is applied to the liquid crystal molecules to move the shield from the second state to the first state.

17. A method of controlling a sensor system, the method comprising:
determining a state of a sensor disposed behind a shield;
increasing an opacity of the shield when the state of the sensor is in an OFF state; and
reducing an opacity of the shield when the state of the sensor is in an ON state.

18. The method of claim 17, wherein increasing the opacity of the shield includes making the sensor invisible through the shield.

19. The method of claim 17, wherein reducing the opacity of the shield includes making the sensor visible through the shield.

20. The method of claim 17, wherein reducing the opacity of the shield includes applying a voltage to the shield.

21. The method of claim 20, wherein applying a voltage to the shield includes applying a voltage to liquid crystal molecules to align the liquid crystal molecules and permit incident light to pass through the shield.
